(19) United States
(12) Patent Application Publication
(10) Pub. No.: US 2011/0243055 A1
(43) Pub. Date: Oct. 6, 2011

(54) Method and Apparatus for Packet Aggregation Transmission

(75) Inventors: Stefan Keller, Karlsruhe (DE); Mattias Lampe, Wolfenbuettel (DE); Zhi Jun Li, Beijing (CN); Ji Feng Tian, Beijing (CN)

(73) Assignee: Siemens Aktiengesellschaft, Munchen (DE)

(21) Appl. No.: 13/074,775

(22) Filed: Mar. 29, 2011

(30) Foreign Application Priority Data
Mar. 31, 2010 (CN) 201010137696.4

(51) Int. Cl. H04W 4/06

(52) U.S. Cl. 370/312

(57) ABSTRACT

A method and apparatus for packet aggregation transmission which are for application in a system comprising a transmitting end and at least two receiving ends, wherein the method comprises, for each receiving end, determining respectively a hold-up condition of subpackets at the transmitting and receiving ends at the current transmitting time, and determining the receiving end corresponding to the worst hold-up condition of the subpackets at the transmitting and receiving ends, and performing a packet aggregation transmission to the determined receiving end at the current transmitting time. The present invention is directed to point-to-multipoint data transmission, can solve the problem of transmission time sequence for a plurality of receiving ends, and improves the instantaneity of a system to the maximum degree possible.

### BACKGROUND OF THE INVENTION

1. Field of the Invention

The present invention relates to the technical field of mobile communication and, more particularly, to a method and apparatus for packet aggregation transmission.

2. Description of the Related Art

The new 802.11n standard is a wireless local area network (WLAN) standard that has been developed rapidly. The 802.11n standard utilizes new technologies in the Media Access Control (MAC) layer and physical layer. Accordingly, the 802.11 n standard has a throughput that is far higher than that of existing WLAN standards, such as 802.11a, 802.11b and 802.11g, which can be up to 600 Mbps. Here, one new technology is packet aggregation, in which each data packet (i.e., a subpacket) that is received from an MAC service access point (SAP) is aggregated as a big aggregated packet that is then transmitted on the physical layer, and only one block response (Block ACK) needs to be fed back for all the subpackets in this aggregated packet rather than feeding back a respective acknowledge (ACK) for each subpacket.

The transmission process of the data packets in the packet aggregation technology is shown in FIG. 1, which mainly comprises the following steps:

Step 101: a transmitting end sends the subpackets in a transmitting cache into a transmitting queue, where the transmitting queue may comprise the subpackets that need to be retransmitted due to a transmission failure in a previous transmission of an aggregated packet.

At the transmitting end, each subpacket received from the MAC SAP is usually initially sent into the transmitting cache. Here, using the data transmission example shown in FIG. 2, subpackets S1, S2, S3, S4 and S5 in the transmitting cache are initially sent into the transmitting queue, assuming there is a subpacket SO that needs to be retransmitted in the queue at this moment.

Step 102: the subpackets in the transmitting queue are aggregated as an aggregated packet, and the packet is sent out after having been encapsulated in the physical layer.

Due to the use of the aggregation technology, when performing a physical layer encapsulation, it only needs to encapsulate all the subpackets in the transmitting queue into one physical frame. S0, S1, S2, S3, S4 and S5 are aggregated into an aggregated packet as depicted in FIG. 2.

Step 103: after having received the aggregated packet, a receiving end performs a cyclic redundancy check (CRC) to determine the subpackets that failed during transmission and to feed back the data transmission condition to the transmitting end by a Block ACK.

Step 104: the receiving end inserts the successfully transmitted subpackets into a receiving cache in accordance with the serial numbers and reserves positions in the receiving cache for the subpackets that failed during transmission in accordance with the serial numbers.

Assuming the subpacket S2 is a subpacket that failed during transmission, the receiving end would insert the subpackets S0, S1, S3, S4 and S5 successfully transmitted into the receiving cache and reserve a corresponding position for S2.

Step 105: the receiving end sends each subpacket before the first subpacket that failed during transmission in the current receiving cache to the upper layer for processing.

As shown in FIG. 2, the receiving end sends S0 and S1 to the tenth layer for processing.

Step 106: the transmitting end releases each successfully transmitted subpacket from the transmitting queue in accordance with the received Block ACK; and proceeds to step 101 during the next aggregation transmission.

The transmitting end releases the successfully transmitted S0, S1, S3, S4 and S5 from the transmitting queue, and then only S2 (i.e., the subpacket that needs to be retransmitted during the next aggregation transmission) remains in the transmitting queue.

During the next aggregation transmission, as shown in FIG. 2, the transmitting end sends S6, S7, S8 and S9 in the transmitting cache into the transmitting queue; and then aggregates S2, S6, S7, S8 and S9 in the transmitting queue as an aggregated packet and sends the aggregated packet out. After having received the aggregated packet, assuming all the subpackets are transmitted successfully, the receiving end sends the received subpackets into the receiving cache in accordance with the serial numbers. Here, there is no subpacket that failed during transmission. Consequently, all the subpackets in the receiving cache can be sent to the upper layer.

It can be seen that in the packet aggregation transmission technology, the throughput and the instantaneity of a system are restrictive to each other, and that although the number of the aggregated subpackets increases the throughput of the system, the number of the aggregated subpackets increases the length of the aggregated packet, thus increasing the transmission time and the retransmission time for the data packets. The bigger the number of the subpackets, the bigger the system throughput, but the poorer the instantaneity.

Even if a mechanism exists for flexibly changing the aggregated number of the subpackets in the known packet aggregation transmission method, i.e., the largest aggregated number is defined, and if the number of the subpackets in the transmitting queue is smaller than the defined largest aggregated number, then all the subpackets in the transmitting queue are aggregated as one aggregated packet; otherwise, only the subpackets of the largest aggregated number are aggregated as one aggregated packet, thus the system throughput and the data transmission instantaneity can be balanced as much as possible.

However, the existing packet aggregation transmission method is directed to point-to-point transmission, and for a point-to-multipoint transmission scenario, the existing packet aggregation transmission method relates to the transmission time sequence problem for a plurality of receiving ends, i.e., to which receiving end the packet aggregation transmission is to be performed at the current moment so that it can improve the system instantaneity as much as possible. Currently, there is no packet aggregation transmission method for point-to-multipoint transmission.

Furthermore, since certain subpackets fail during transmission, the receiving end has a strict requirement as to the order of the subpackets. In addition, only after the subpacket that failed during transmission has been successfully retransmitted, is it possible for each subpacket after the failed subpacket in the receiving cache to be sent to the upper layer, this phenomena being referred to herein as a hold-up effect, which seriously affects the instantaneity of the data transmission. Therefore, the existing packet aggregation transmission method cannot significantly improve the instantaneity of the data transmission based on ensuring the system throughput.

### SUMMARY OF THE INVENTION

It is therefore an object of the present invention to provide a method and apparatus for packet aggregation transmission so as to improve the instantaneity of the data transmission to a maximum extent in a point-to-multipoint transmission scenario.

This and other objects and advantages are achieved in accordance with the invention by providing a method and apparatus for packet aggregation transmission so as to reduce the hold-up effect of the receiving end and improve the instantaneity of the data transmission.

In accordance with the invention, the method for packet aggregation transmission is applied in a system comprising a transmitting end and at least two receiving ends, where the method comprises:

A. determining, for each respective receiving end, a hold-up condition of subpackets at transmitting and receiving ends at a current transmitting time; and

B. determining the receiving end corresponding to the worst hold-up condition of the subpackets at the transmitting and receiving ends, and performing a packet aggregation transmission to a determined receiving end at the current transmitting time.

Here, the hold-up condition of the subpackets at the transmitting and receiving ends is a sum Nᵢ of the number of the subpackets held-up at the transmitting and receiving ends, where i is an identifier of the receiving end. In addition, the receiving end corresponding to the worst hold-up condition of the subpackets at the transmitting and receiving ends is the receiving end corresponding to the maximum value of Nᵢ.

When the system uses a mechanism of distributed coordination function (DCF), Nᵢ is Nᵢ=Sᵢ^{D1}−Sᵢ^{D2}, where Sᵢ^{D1} is the largest serial number of the subpacket in the transmitting cache at the transmitting end corresponding to the receiving end with the identifier i at the current transmitting time, and Sᵢ^{D2} is the smallest serial number of the subpacket in the transmitting queue at the transmitting end corresponding to the receiving end with the identifier i at the current transmitting time.

Moreover, when the system uses a mechanism of point coordination function (PCF), Nᵢ is Nᵢ=aᵢ(Sᵢ^{D1}−Sᵢ^{D2})+bᵢ(Sᵢ^{U1}+Sᵢ^{U2}), where Sᵢ^{U1} is the largest serial number of the subpacket in the receiving cache at the transmitting end corresponding to the receiving end with the identifier i at the current transmitting time, Sᵢ^{U2} is the smallest serial number of the subpacket in the receiving cache at the transmitting end corresponding to the receiving end with the identifier i at the current transmitting time, aᵢ is a weight value of a transmission urgency of downstream data corresponding to the receiving end with the identifier i, and bᵢ is a weight value of a transmission urgency of the upstream data corresponding to the receiving end with the identifier i.

The hold-up condition of the subpackets at the transmitting and the receiving ends is the hold-up time period Tᵢ of the subpackets at the transmitting end and the receiving end, where i is an identifier of the receiving end.

Moreover, the receiving end corresponding to the worst hold-up condition of the subpackets at the transmitting and receiving ends is a receiving end corresponding to the maximum value of Tᵢ.

When the system uses a mechanism of distributed coordination function (DCF), Tᵢ is Tᵢ=Tᵢ^{D1}−Tᵢ^{D2}, where Tᵢ^{D1} is the largest time stamp value of the subpacket in the transmitting cache at the transmitting end corresponding to the receiving end with the identifier i at the current transmitting time, and Tᵢ^{D2} is the smallest time stamp value of the subpacket in the transmitting queue at the transmitting end corresponding to the receiving end with the identifier i at the current transmitting time.

Moreover, when the system uses a mechanism of point coordination function PCF, said Tᵢ is Tᵢ=aᵢ(Tᵢ^{D1}−Tᵢ^{D2})+bᵢ(Tᵢ^{U1}+Tᵢ^{U2}), where Tᵢ^{U1} is the largest time stamp value of the subpacket in the receiving cache at the transmitting end corresponding to the receiving end with the identifier i at the current transmitting time, Tᵢ^{U2} is the smallest time stamp value of the subpacket in the receiving cache at the transmitting end corresponding to the receiving end with the identifier i at the current transmitting time, aᵢ is the weight value of the transmission urgency of the downstream data corresponding to the receiving end with the identifier i, and bᵢ is a weight value of the transmission urgency of the upstream data corresponding to the receiving end with the identifier i.

After step B, the method further comprises: deleting by the transmitting end the successfully transmitted subpackets from the transmitting queue at the transmitting end corresponding to the determined receiving end in accordance with a returned response from the receiving end regarding the packet aggregation transmission, and proceeding to step A at the next transmitting time.

The apparatus for packet aggregation transmission configured for application in a system comprises a transmitting end and at least two receiving ends, where the apparatus is set at the transmitting end, and the apparatus comprises a hold-up condition determination unit, a receiving end determination unit and an aggregation transmission unit.

The hold-up condition determination unit is used for determining the hold-up condition of the subpackets at the transmitting and the receiving ends for each receiving end at the current transmitting time.

The receiving end determination unit is used for determining the receiving end corresponding to the worst hold-up condition of the subpackets at the transmitting and receiving ends.

The aggregation transmission unit is used for performing a packet aggregation transmission to the receiving end determined by the receiving end determination unit at the current transmitting time.

The hold-up condition of the subpackets at the transmitting and the receiving ends is the sum Nᵢ of the number of the subpackets held-up at the transmitting and receiving ends, where i is an identifier of the receiving end.

Moreover, the receiving end corresponding to the worst hold-up condition of the subpackets at the transmitting end and the receiving end is the receiving end corresponding to the maximum value of Nᵢ.

When the system uses the DCF mechanism, the hold-up condition determination unit comprises a first serial number determination sub-unit for determining Sᵢ^{D1} and Sᵢ^{D2} for each respective receiving end, where Sᵢ^{D1} is the largest serial number of the subpacket in the transmitting cache at the transmitting end corresponding to the receiving end with the identifier i at the current transmitting time, and Sᵢ^{D2} is the smallest serial number of the subpacket in the transmitting queue at the transmitting end corresponding to the receiving end with the identifier i at the current transmitting time. The hold-up condition determination also comprises a first hold-up number determination sub-unit for determining the number Nᵢ of the subpackets held up at the transmitting end and the receiving end according to Nᵢ=Sᵢ^{D1}−Sᵢ^{D2}.

When the system uses the PCF mechanism, the hold-up condition determination unit comprises a second serial number determination sub-unit for determining Sᵢ^{D1}, Sᵢ^{D2}, Sᵢ^{U1} and Sᵢ^{U2} for each respective receiving end, where Sᵢ^{U1} is the largest serial number of the subpacket in the receiving cache at the transmitting end corresponding to the receiving end with the identifier i at the current transmitting time, and Sᵢ^{U2} is the smallest serial number of the subpacket in the receiving cache at the transmitting end corresponding to the receiving end with the identifier i at the current transmitting time.

The hold-up condition determination unit comprises a second hold-up number determination sub-unit for determining the number Nᵢ of the subpackets held-up at the transmitting and receiving ends in accordance with Nᵢ=aᵢ(Sᵢ^{D1}−Sᵢ^{D2})+bᵢ(Sᵢ^{U1}−Sᵢ^{U2}), where aᵢ is a weight value of the transmission urgency of the downstream data corresponding to the receiving end with the identifier i, and bᵢ is a weight value of the transmission urgency of the upstream data corresponding to the receiving end with the identifier i.

The hold-up condition of the subpackets at the transmitting and the receiving ends is the hold-up time period Tᵢ of the subpackets at the transmitting and receiving ends, where i is an identifier of the receiving end.

Moreover, the receiving end corresponding to the worst hold-up condition of the subpackets at the transmitting end and the receiving end is the receiving end corresponding to the maximum value of Tᵢ.

When the system uses the DCF mechanism, the hold-up condition determination unit comprises a first time stamp determination sub-unit for determining Tᵢ^{D1} and Tᵢ^{D2} for each respective receiving end, where Tᵢ^{D1} is the largest time stamp value of the subpacket in the transmitting cache at the transmitting end corresponding to the receiving end with the identifier i at the current transmitting time, and Tᵢ^{D2} is the smallest time stamp value of the subpacket in the transmitting queue at the transmitting end corresponding to the receiving end with the identifier i at the current transmitting time.

Moreover, the hold-up condition determination unit comprises a first hold-up time period determination sub-unit for determining the sum Tᵢ of the hold-up time period of the subpackets at the transmitting end and the receiving end according to Tᵢ=Tᵢ^{D1}−Tᵢ^{D2}.

When the system uses the PCF mechanism, the hold-up condition determination unit comprises a second time stamp determination sub-unit for determining Tᵢ^{D1}, Tᵢ^{D2}, Tᵢ^{U1} and Tᵢ^{U2} for each respective receiving end, where Tᵢ^{U1} is the largest time stamp value of the subpacket in the receiving cache at the transmitting end corresponding to the receiving end with the identifier i at the current transmitting time, and Tᵢ^{U2} is the smallest time stamp value of the subpacket in the receiving cache at the transmitting end corresponding to the receiving end with the identifier i at the current transmitting time.

Moreover, the hold-up condition determination unit comprises a second hold-up time period determination sub-unit for determining the sum Tᵢ of the hold-up time period of the subpackets at the transmitting and receiving ends in accordance with Tᵢ=aᵢ(Tᵢ^{D1}−Tᵢ^{D2})+bᵢ(Tᵢ^{U1}−Tᵢ^{U2}), where aᵢ is a weight value of a transmission urgency of downstream data corresponding to the receiving end with the identifier i, and bᵢ is a weight value of transmission urgency of the upstream data corresponding to the receiving end with the identifier i.

More preferably, the apparatus further comprises a transmission response processing unit for deleting successfully transmitted subpackets from the transmitting queue at the transmitting end corresponding to the determined receiving end in accordance with a returned response from the receiving end regarding the packet aggregation transmission.

In alternative embodiment, the method for packet aggregation transmission comprises after having deleted the successfully transmitted subpackets from a transmitting queue in accordance with a returned response from a receiving end regarding a packet aggregation transmission, duplicating by a transmitting end N copies of the subpackets to be retransmitted in the transmitting queue, and performing a packet aggregation transmission to the N subpackets together with the subpackets sent into the transmitting queue from a transmitting cache, where N is an integer greater than 1.

In accordance with the alternative embodiment, N is a preset value, N is a value related to the retransmission times for said subpackets to be retransmitted or N is a value related to the instantaneity requirement at the receiving end.

In particular, during the packet aggregation transmission, N subpackets are placed at a position set in the aggregated packet or placed at a position calculated randomly or pseudo-randomly in the aggregated packet.

The present invention further provides another embodiments of an apparatus for packet aggregation transmission, the apparatus being set at a transmitting end, where the apparatus comprises a response processing unit, a packet duplication unit and an aggregation transmission unit.

Here, the response processing unit is used for deleting successfully transmitted subpackets from a transmitting queue in accordance with a returned response from a receiving end regarding a packet aggregation transmission and for sending a process notification to the packet duplication unit.

The packet duplication unit is used for duplicating N copies of the subpackets to be retransmitted in the transmitting queue after having received the process notification.

The aggregation transmission unit is used for performing a packet aggregation transmission of the duplicated N subpackets together with the subpackets sent into the transmitting queue from a transmitting cache.

In this case, N is an integer greater than 1, N is a preset value, N is a value related to the retransmission times for said subpackets to be retransmitted and/or N is a value related to the instantaneity requirement at said receiving end.

During the process of performing the packet aggregation transmission, the aggregation transmission unit places N subpackets at a position set in the aggregated packet or at a position calculated randomly or pseudo-randomly in the aggregated packet.

It can be seen from the above technical solutions that the present invention provides a particular method for packet aggregation transmission for the point-to-multipoint transmission scenario, determines for each receiving end a hold-up condition of the subpackets at the transmitting and receiving ends, determines the receiving end corresponding to the worst hold-up condition of the subpackets at the transmitting end and the receiving end, and performs at the current transmitting time a preferential packet aggregation transmission to this receiving end. By solving the problem of transmission time sequence for a plurality of receiving ends in this way, the method improves the system instantaneity to the maximum degree.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to make the objects, technical solutions and advantages of the present invention more apparent, the present invention will be described hereinbelow in detail in conjunction with the accompanying drawings and particular embodiments, in which:

FIG. 1 is a schematic diagram of the flow in an existing packet aggregation transmission technology;

FIG. 2 is an exemplary illustration of an existing packet aggregation transmission technology;

FIG. 3 is a flowchart of a method in accordance with an embodiment of the invention;

FIG. 4 is a flowchart of a method in accordance with an alternative embodiment of the invention;

FIG. 5 is a flowchart of a method in accordance with another embodiment of the invention;

FIG. 6 is an exemplary illustration of the embodiment of FIG. 5;

FIG. 7 is a schematic block diagram of the structure of an apparatus in accordance with the invention;

FIG. 8 is a schematic block diagram of the structure of an apparatus in accordance with an alternative embodiment of the invention;

FIG. 9 is an exemplary illustration of a method in accordance with another embodiment of the invention; and

FIG. 10 is a schematic block diagram of the structure of an apparatus in accordance with another embodiment of the invention.

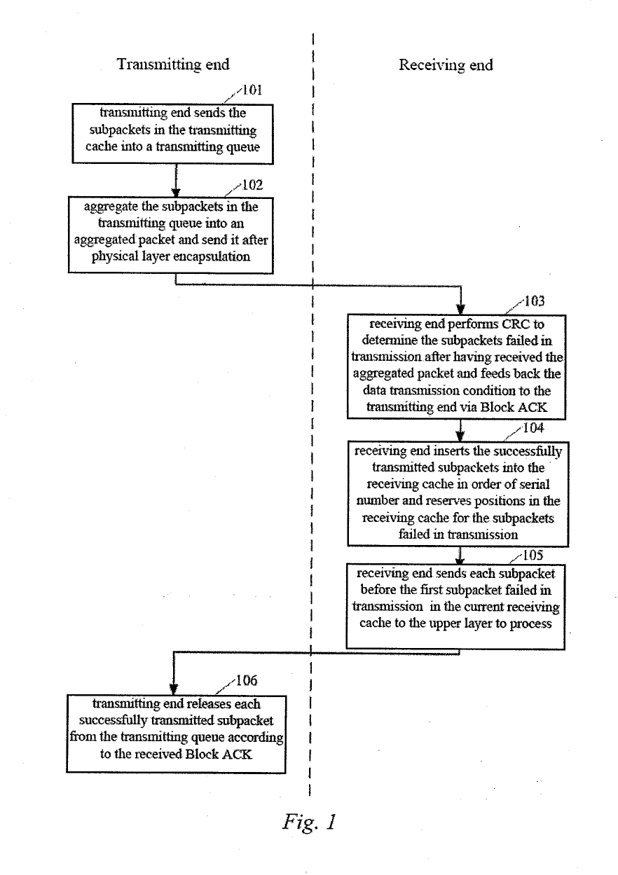

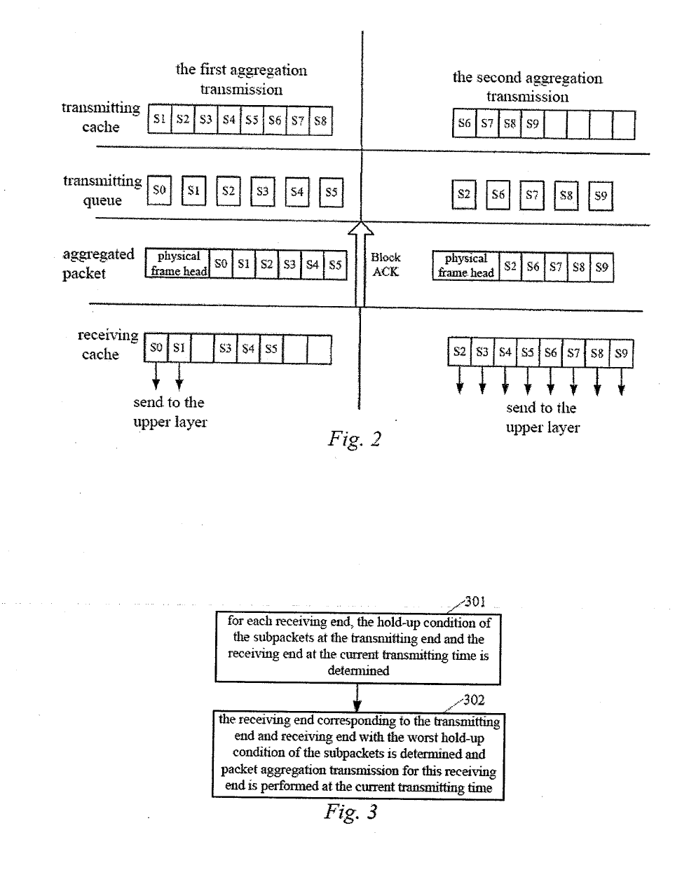

### DETAILED DESCRIPTION OF THE PRESENTLY PREFERRED EMBODIMENTS

In the scenario of a point-to-multipoint transmission, it is a desire for the entire transmission system to meet the requirement of instantaneity, which mainly depends on service quality requirements and transmission urgency. However, instead, the present invention does not take the service quality requirements into consideration, assuming the service quality requirements of each receiving end are the same, and the transmission time sequence of the receiving end is determined based mainly on the transmission urgency at each receiving end. FIG. 3 is a flow chart of a method in accordance with the invention. The method mainly comprises:

Step 301: a hold-up condition of the subpackets at the transmitting and receiving ends at the current transmitting time is determined for each receiving end.

Here, the hold-up condition of subpackets at the transmitting and receiving ends can be the sum Nᵢ of the number of subpackets held-up at the transmitting and receiving ends. Alternatively, the hold-up condition of subpackets at the transmitting and receiving ends can be the sum Tᵢ of the hold-up time period of the subpackets at the transmitting and receiving ends, where i is an identifier of each receiving end.

Step 302: the receiving end corresponding to the worst hold-up condition of the subpackets at the transmitting and receiving ends is determined, and a packet aggregation transmission is performed to the determined receiving end at the current transmitting time.

When the hold-up condition is the sum Nᵢ of the number of the hold-up subpackets, the receiving end corresponding to the largest value of Nᵢ is determined; and when the hold-up condition is the hold-up time period Tᵢ of the subpackets, the receiving end corresponding to the biggest value of Tᵢ is determined.

In conventional wireless communication methodologies, there are mainly two time sequence allocation mechanisms, i.e., the distributed coordination function (DCF) and the point coordination function (PCF). Here, DCF is a mechanism that is most widely applied in the existing IEEE 802.11 WLAN system. In DCF, moreover, each client performs channel access by competition. In PCF, on the other hand, the access points (AP) allow each client to perform channel access by a poll so as to implement the transmission of upstream and downstream data. As described below, two embodiments are provided, i.e., one for DCF and one for PCF to describe in detail the method in accordance the invention.

### Embodiment I

In the DCF mechanism, each client performs channel access by competition, and only the transmission time sequence of downstream data is collectively controlled by an AP. Therefore, the method in accordance with the presently contemplated embodiment is used for downstream data transmission to clients at the AP side. Under the assumption that there are N clients at this AP in the system, then there is a transmitting cache and transmitting queue respectively for the downstream transmission of these N clients at the AP side.

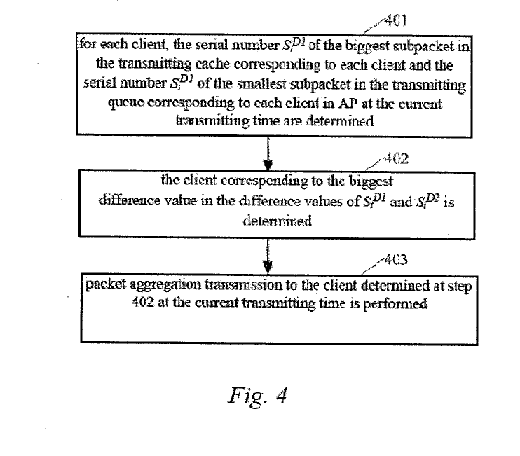

FIG. 4 is a schematic block diagram of the method in accordance with the contemplated embodiment I, where the method particularly comprising the following steps:

Step 401: the largest serial number Sᵢ^{D1} of the subpacket in the transmitting cache corresponding to each client in the AP and the smallest serial number Sᵢ^{D2} of the subpacket in the transmitting queue corresponding to each client at the current transmitting time are determined for each client, where i is an identifier of each client, and i=1, 2, . . . , N.

If the current transmitting time is the first transmitting time, then there is possibly no subpacket in the transmitting queue corresponding to the client, and the smallest serial number S^{D2} of the subpacket in the transmitting queue is 0.

If the current transmitting time is not the first transmitting time, then before this step, after the AP has received a Block ACK, successfully transmitted subpackets in a previous packet aggregation transmission are first deleted from the transmitting queue corresponding to the client in the AP.

Step 402: the client corresponding to the biggest difference value in the difference values between Sᵢ^{D1} and Sᵢ^{D2} is determined.

Step 403: a packet aggregation transmission is performed to the client determined at step 402 at the current transmitting time.

There is a part of subpackets held-up and to be retransmitted in the transmitting cache, at the same time there is a part of subpackets held up in the receiving queue of the receiving end, and the subpackets held up in the receiving queue of the receiving end are the subpackets after the subpackets to be retransmitted with the smallest serial number, where the smallest serial number in the transmitting queue is the smallest serial number in the subpackets to be retransmitted. As a result, the difference value between the biggest serial number Sᵢ^{D1} of the subpackets in the transmitting cache and the smallest serial number Sᵢ^{D2} of the subpackets in the transmitting queue merely reflects the sum Nᵢ of the number of hold-up subpackets at the transmitting end and the receiving end.

The larger the sum of the number of the hold-up subpackets at the transmitting and receiving ends, the higher the transmission urgency of the receiving end (i.e. the client in the presently contemplated embodiment) that it indicates. Moreover, in order to meet the instantaneity requirements of this client, the packet aggregation transmission of this client is preferably performed at the current time. That is, the AP sends the subpackets in the transmitting cache corresponding to this client into the transmitting queue, aggregates the subpackets not exceeding the largest aggregation number in the transmitting queue, and then sends the aggregated subpackets to this client.

After having received the Block ACK returned from this client, the successfully transmitted subpackets are deleted from the transmitting queue corresponding to this client in AP, and then the method proceeds to step 401.

### Embodiment II

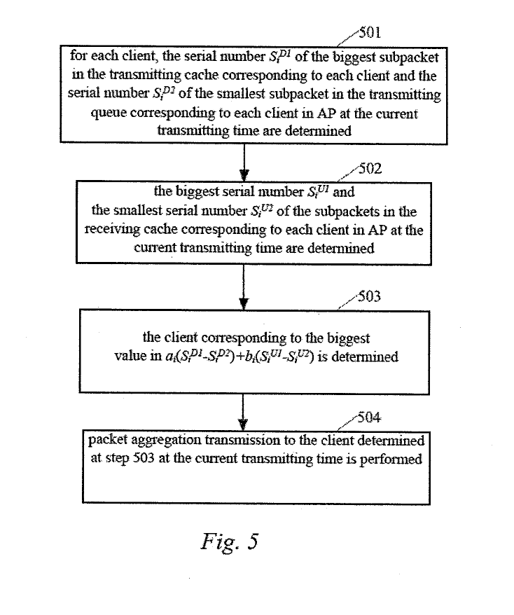

In the PCF mechanism, the upstream and downstream data transmissions are both collectively controlled by the AP, and the AP polls each client in accordance with a preset poll order, and the polled client can perform data transmission when there is data transmission. The PCF mechanism is different from the DCF mechanism in that in the PCF mechanism the transmission urgency of each client needs to consider not only downstream data but also upstream data. Assuming there are N clients at this AP in the system, then there is a transmitting cache and transmitting queue respectively for the downstream transmission of these N clients at the AP side, i.e., simultaneously there are N transmitting caches and N transmitting queues, there are receiving caches respectively for the upstream transmission of these N clients at the AP side, i.e., there are N receiving caches. FIG. 5 is a schematic diagram of a method in accordance with the presently contemplated embodiment, where the method particularly comprises the following steps:

Step 501: the largest serial number of the subpacket Sᵢ^{D1} in the transmitting cache corresponding to each client in the AP at the current transmitting time and the smallest serial number of the subpacket Sᵢ^{D2} in the transmitting queue corresponding to each client are determined for each client, where i is an identifier of each client, i=1, 2, . . . , N.

Step 502: the largest serial number Sᵢ^{U1} and the smallest serial number Sᵢ^{U2} of the subpackets in the receiving cache corresponding to each client in AP at the current transmitting time are determined.

Here, the receiving cache corresponding to each client in AP is used to cache the upstream data sent by this client. Similarly, if the transmission fails, then the subpackets before the smallest serial number in the upstream data transmitted in failure are sent to the upper layer, and the remaining subpackets are the subpackets that are held-up.

Step 503: the client corresponding to the largest value of aᵢ(Sᵢ^{D1}−Sᵢ^{D2})+bᵢ(Sᵢ^{U1}+Sᵢ^{U2}) is determined.

It can be seen from the description of embodiment I that, the difference value between Sᵢ^{D1} and Sᵢ^{D2} corresponding to the client reflects the number of downstream subpackets that are held-up by this client, i.e., the difference value Sᵢ^{D1} and Sᵢ^{D2} reflects the urgency of the downstream data transmission of this client.

The hold-up upstream subpackets are in the receiving cache of upstream data, and the difference value between Sᵢ^{U1} and Sᵢ^{U2} reflects the number of the hold-up upstream subpackets in the receiving cache of the upstream data corresponding to the client with the identifier i, i.e., the difference value between Sᵢ^{U1} and Sᵢ^{U2} reflects the transmission urgency of the upstream data of this client.

Here, aᵢ and bᵢ are the weight values of the transmission urgency of the downstream data and the upstream data corresponding to the client with the identifier i, and aᵢ and bᵢ of each client can be the same or different, when the requirements of the transmission urgency of downstream data is high, aᵢ can be set to be relatively high, and when the requirements of the transmission urgency of upstream data is high, bᵢ can be set to be relatively high. As a whole, the value of aᵢ(Sᵢ^{D1}−Sᵢ^{D2})+bᵢ(Sᵢ^{U1}+Sᵢ^{U2}) reflects the urgency of the upstream and downstream data transmission of the client with the identifier i.

Step 504: a packet aggregation transmission is performed to the client that is determined at step 503 at the current transmitting time.

In this step, the packet aggregation transmission performed to the determined client comprises the AP initially performing downstream packet aggregation transmission to this client, and the AP performing upstream packet aggregation transmission after the client has fed back a Block ACK for this packet aggregation transmission.

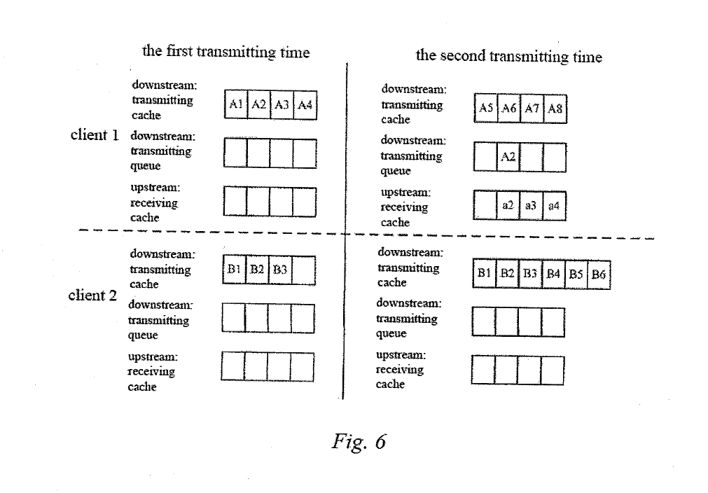

Hereinbelow, the method provided by embodiment II will be described by way of a particular example, and for simplicity, it is assumed that the AP only corresponds to two clients in the system, as shown in FIG. 6.

First, for client 1 and client 2, the AP respectively determines the largest serial number of the subpacket S₁^{D1} in the transmitting cache corresponding to client 1 in the AP is 4 at a first transmitting time, determines the smallest serial number of the subpacket S₁^{D2} in the transmitting queue corresponding to client 1 is 0, determines the largest serial number of the subpacket S₂^{D1} in the transmitting cache corresponding to client 2 in the AP is 3, and determines that the smallest serial number of the subpacket S₂^{D2} in the transmitting queue corresponding to client 2 is 0. At the current time, the largest serial number S₁^{U1} and the smallest serial number S₁^{U2} of the subpackets in the receiving cache for upstream data corresponding to client 1 are both 0, and the largest serial number S₂^{U1} and the smallest serial number S₂^{U2} of the subpackets in the receiving cache for upstream data corresponding to client 2 are both 0.

If the urgency of upstream data transmission and downstream data transmission of client 1 are the same, then both a₁ and b₁ are 1, and if the urgency of upstream data transmission and downstream data transmission of client 2 are the same also, then both a₂ and b₂ are 1. Then a₁(S₁^{D1}−S₁^{D2})+b₂(S₂^{U1}+S₂^{U2})=4 (corresponding to client 1) and a₂(S₂^{D1}−S₂^{D2})+b₂(S₂^{U1}+S₂^{U2})=3 (corresponding to client 2), which indicates that the transmission urgency of client 1 is relatively high and performs packet aggregation transmission to client 1 at the current time.

If transmission of the downstream subpackets A2 failed during the packet aggregation transmission and other subpackets are transmitted successfully, then client 1 returns a Block ACK to the AP and performs packet aggregation transmission with ten lines of data, assuming a2 is transmitted in failure, then a2, a3 and a4 are held-up in the receiving cache for client 1. The AP releases the successfully transmitted A1, A3 and A4 from the transmitting queue in accordance with the Block ACK returned by client 1 and only holds A2.

By then, at the second transmitting time, for client 1 and client 2, the AP determines respectively the largest serial number of the subpacket S₁^{D1} in the transmitting cache corresponding to client 1 in the AP to be 8 at the first transmitting time, determines the smallest serial number of the subpacket S₁^{D2} in the transmitting queue corresponding to client 1 is 2, determines the largest serial number of the subpacket S₂^{D1} in the transmitting cache corresponding to client 2 in the AP is 6, and determines that the smallest serial number of the subpacket S₂^{D2} in the transmitting queue corresponding to client 2 is 0. At the current time, the largest serial number S₁^{U1} and the smallest serial number S₁^{U2} of the subpackets in the receiving cache for upstream data corresponding to client 1 are respectively 4 and 2, and the largest serial number S₂^{U1} and the smallest serial number S₂^{U2} of the subpackets in the receiving cache corresponding to client 2 are respectively 0 and 0.

If a₁(S₁^{D1}−S₁^{D2})+b₂(S₂^{U1}+S₂^{U2})=8 (corresponding to client 1) and a₂(S₂^{D1}−S₂^{D2})+b₂(S₂^{U1}+S₂^{U2})=6 (corresponding to client 2), this indicates that the transmission urgency of client 1 is relatively high. Consequently, the AP determines still performs the packet aggregation transmission to client 1 at the second transmitting time.

At the second transmitting time, for client 1 and in the downstream direction, there are five hold-up subpackets A2, A5, A6, A7 and A8 at the AP end, and there are two hold-up subpackets A3 and A4 for client 1, i.e. there are in total seven hold-up subpackets in the downstream direction, and in the upstream direction, there are three hold-up subpackets a2, a3 and a4 at the AP end. For client 2 and in the downstream direction, only at the AP end are there six hold-up subpackets B1, B2, B3, B4, B5 and B6. Therefore, the transmission urgency of client 1 is higher than that of client 2. It is thus apparent that the above-mentioned method provided by the present contemplated embodiments of the invention and the actual exemplary illustrations are consistent.

Furthermore, in addition to the fact that the method in accordance with the contemplated embodiments reflects transmission urgency by employing the difference of the serial number of the subpackets, the method can also reflect transmission urgency in combination with other parameters on this basis. For example, when the subpackets are sent into the transmitting cache or receiving cache the transmitting end can print a time stamp value on the subpackets, and in each of the above-described embodiments, the serial number is replaced with the time stamp value of each subpacket.

In embodiment I, the last determined client is the client corresponding to the largest value of Tᵢ, where Tᵢ=Tᵢ^{D1}−Tᵢ^{D2}, Tᵢ^{D1} is the largest time stamp value of the subpacket in the transmitting cache corresponding to the client with the identifier i, and Tᵢ^{D2} is the smallest time stamp value of the subpacket in the transmitting queue corresponding to the client with the identifier i.

Likewise, in embodiment II, the last determined client is the client corresponding to the largest value of Tᵢ. Here, Tᵢ=aᵢ(Tᵢ^{D1}−Tᵢ^{D2})+bᵢ(Tᵢ^{U1}−Tᵢ^{U2}), where Tᵢ^{D1} is the largest time stamp value of the subpacket in the transmitting cache corresponding to the client with the identifier i, Tᵢ^{D2} is the smallest time stamp value of the subpacket in the transmitting queue corresponding to the client with the identifier i, Tᵢ^{U1} and Tᵢ^{U2} are the biggest time stamp value of the subpacket and the smallest time stamp value of the subpacket in the receiving cache corresponding to the client with the identifier l respectively, and aᵢ and bᵢ are the weight values of the transmission urgency of the downstream data and upstream data corresponding to the client with the identifier i.

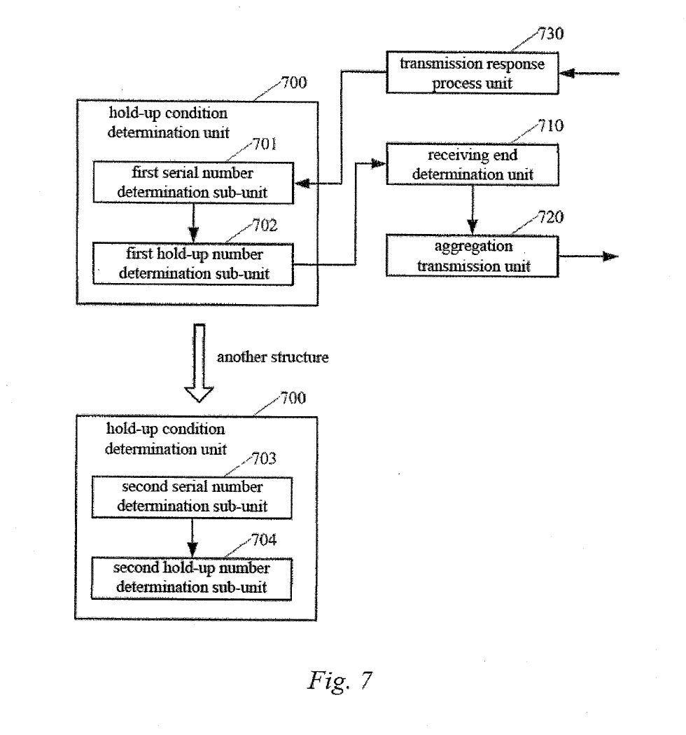

FIG. 7 is a schematic block diagram of the structure apparatus in accordance with an embodiment of the invention, which is for application in a system comprising a transmitting end and at least two receiving ends, where the apparatus is set at the transmitting end, and the apparatus comprises a hold-up condition determination unit 700, a receiving end determination unit 710 and an aggregation transmission unit 720.

The hold-up condition determination unit 700 determines a hold-up condition of the subpackets at the transmitting and receiving ends respectively for each receiving end at the current transmitting time.

The receiving end determination unit 710 determines the receiving end corresponding to the worst hold-up condition of the subpackets at the transmitting and the receiving ends.

The aggregation transmission unit 720 performs a packet aggregation transmission for the receiving end determined by the receiving end determination unit at the current transmitting time.

The apparatus comprises the two situations according to different hold-up conditions. In the first situation, the hold-up condition of the subpackets at the above-mentioned transmitting and receiving ends is a sum Nᵢ of the number of the subpackets held-up at the transmitting and receiving ends, where i is an identifier of the receiving end. The receiving end corresponding to the worst hold-up condition of the subpackets at the transmitting and receiving ends is the receiving end corresponding to the maximum value of Nᵢ.

In this situation, when the system uses a DCF mechanism, the hold-up condition determination unit 700 can comprise, in particular, a first serial number determination sub-unit 701 and a first hold-up number determination sub-unit 702.

The first serial number determination sub-unit 701 determines Sᵢ^{D1} and Sᵢ^{D2} respectively for each receiving end, where Sᵢ^{D1} is the largest serial number of the subpacket in the transmitting cache corresponding to the receiving end with the identifier i at the transmitting end at the current transmitting time, and Sᵢ^{D2} is the smallest serial number of the subpacket in the transmitting queue corresponding to the receiving end with the identifier i at the transmitting end at the current transmitting time.

The first hold-up number determination sub-unit 702 determines the number Nᵢ of the subpackets held up at the transmitting end and the receiving end according to Nᵢ=Sᵢ^{D1}−Sᵢ^{D2}.

Moreover, when the system uses a PCF mechanism, the hold-up condition determination unit can employ another structure, which particularly comprises: a second serial number determination sub-unit 703 and a second hold-up number determination sub-unit 704.

The second serial number determination sub-unit 703 respectively determines Sᵢ^{D1}, Sᵢ^{D2}, Sᵢ^{U1} and Sᵢ^{U2} for each receiving end, where Sᵢ^{D1} is the largest serial number of the subpacket in the transmitting cache corresponding to the receiving end with the identifier i at the current transmitting time, Sᵢ^{D2} is the smallest serial number of the subpacket in the transmitting queue corresponding to the receiving end with the identifier i at the current transmitting time, Sᵢ^{U1} is the largest serial number of the subpacket in the receiving cache corresponding to the receiving end with the identifier i at the current transmitting time, and Sᵢ^{U2} and is the smallest serial number of the subpacket in the receiving cache corresponding to the receiving end with the identifier i at the current transmitting time.

The second hold-up number determination sub-unit 704 determines the number Nᵢ of the subpackets held-up at the transmitting end and the receiving end in accordance with Nᵢ=aᵢ(Sᵢ^{D1}−Sᵢ^{D2})+bᵢ(Sᵢ^{U1}−Sᵢ^{U2}), where aᵢ is the weight value of the transmission urgency of the downstream data corresponding to the receiving end with the identifier i, and bᵢ is the weight value of the transmission urgency of the upstream data corresponding to the receiving end with the identifier i.

In the second situation, the hold-up condition of the subpackets at the transmitting end and the receiving end is the sum Tᵢ of the hold-up time period of the subpackets at the transmitting end and receiving end, wherein i is an identifier of the receiving end. The receiving end corresponding to the worst hold-up condition of the subpackets at the transmitting end and the receiving end is the receiving end corresponding to the maximum value of Tᵢ.

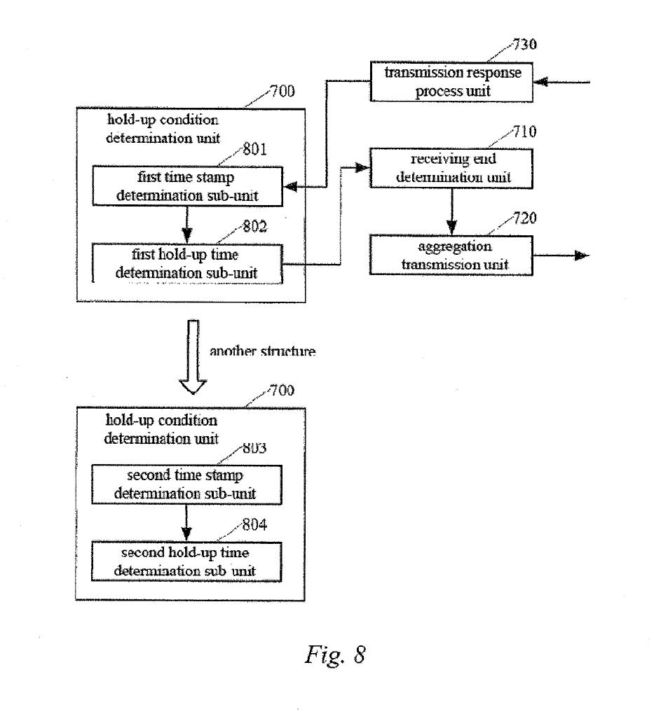

When the system uses a DCF mechanism, as shown in FIG. 8, the hold-up condition determination unit 700 at this moment may comprise, i.e., a first time stamp determination sub-unit 801 and a first hold-up time period determination sub-unit 802.

The first time stamp determination sub-unit 801 determines Tᵢ^{D1} and Tᵢ^{D2} respectively for each receiving end, where Tᵢ^{D1} is the largest time stamp value of the subpacket in the transmitting cache at the transmitting end corresponding to the receiving end with the identifier i at the current transmitting time, and Tᵢ^{D2} is the smallest time stamp value of the subpacket in the transmitting queue at the transmitting end corresponding to the receiving end with the identifier i at the current transmitting time.

The hold-up time period determination sub-unit 802 determines the sum Tᵢ of the hold-up time period of the subpackets at the transmitting and receiving ends in accordance with Tᵢ=Tᵢ^{D1}−Tᵢ^{D2}.

When the system uses a PCF mechanism, as shown in FIG. 8, the hold-up condition determination unit 700 uses alternative structure, which particularly comprises a second time stamp value determination sub-unit 803 and a second hold-up number determination sub-unit 804.

The second time stamp determination sub-unit determines Tᵢ^{D1}, Tᵢ^{D2}, Tᵢ^{U1} and Tᵢ^{U2} respectively for each receiving end, where Tᵢ^{U1} is the largest time stamp value of the subpacket in the receiving cache at the transmitting end corresponding to the receiving end with the identifier i at the current transmitting time, and Tᵢ^{U2} is the smallest time stamp value of the subpacket at the transmitting end in the receiving cache corresponding to the receiving end with the identifier i at the current transmitting time.

Here, the second hold-up time period determination sub-unit 804 determines the sum Tᵢ of the hold-up time period of the subpackets at the transmitting and receiving ends in accordance with Tᵢ=aᵢ(Tᵢ^{D1}−Tᵢ^{D2})+bᵢ(Tᵢ^{U1}−Tᵢ^{U2}), where aᵢ is the weight value of the transmission urgency of the downstream data corresponding to the receiving end with the identifier i, and bᵢ is the weight value of the transmission urgency of the upstream data corresponding to the receiving end with the identifier i.

Moreover, in alternative embodiments of the structure depicted in FIGS. 7 and 8, the apparatus may further comprises a transmission response processing unit 730, which can delete the successfully transmitted subpackets from the transmitting queue at the transmitting end corresponding to the determined receiving end in accordance with a returned response from the receiving end regarding the packet aggregation transmission. The hold-up condition determination unit 700 then determines respectively for each receiving end the hold-up condition of the subpackets at the transmitting end and the receiving end at the next transmitting time.

The above is a technical solution provided for point-to-multipoint transmission scenarios, and hereinbelow, the technical solution solving hold-up effect is described. The main method provided for addressing problem associated with the hold-up effect comprises after having deleted the successfully transmitted subpackets from the transmitting queue in accordance with a returned response from the receiving end regarding the packet aggregation transmission, the transmitting end duplicates N copies of the subpackets to be retransmitted in the transmitting queue and performs a packet aggregation transmission to the N subpackets together with the subpackets sent into the transmitting queue from the transmitting cache, where N is an integer greater than 1.

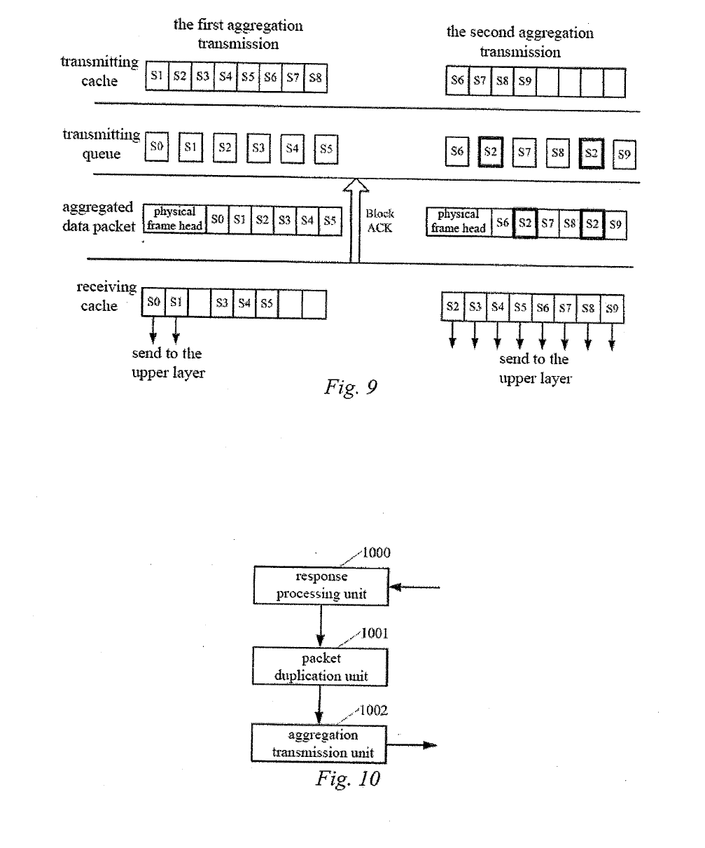

FIG. 9 is an exemplary illustration of a method in accordance with another embodiment of the invention.

In the presently contemplated embodiment, i.e., embodiment III, it is assumed that during the first packet aggregation transmission, S0, S1, S2, S3, S4 and S5 are included in the transmitting queue. After the first packet aggregation transmission, S2 fails in transmission, and the receiving end returns a Block Ack to report the transmission condition. In addition, the subpackets S0 and S1 before the subpacket S2 that failed in transmission are sent to the upper layer, while S3, S4 and S5 are held-up in the receiving cache of the receiving end.

After having received the Block Ack, the transmitting end deletes the successfully transmitted subpackets S0, S1, S3, S4 and S5 from the transmitting queue, duplicates N copies of the subpacket S2 that needs to be retransmitted, taking duplicating 2 copies as an example in FIG. 9, and then performs packet aggregation transmission in combination with other subpackets S6, S7, S8 and S9 sent into the transmitting queue by the transmitting cache.

In accordance with the presently disclosed embodiments of the invention, the strategy of duplicating subpackets can have a variety of settings, such as in addition to setting N to a fixed value, the value of N can also be set flexibly in accordance with the number of times of retransmission. For example, set N=f(M), where f is a function with the value of M being a variant, in which M is the number of times of the retransmission of this subpacket. For example, it can be set f(M)=M+1, i.e., N=M+l; when performing the first retransmission, this subpacket is duplicated to 2 copies, and when performing the second retransmission, this subpacket is duplicated to 3 copies, etc.

The value of N can also be determined based on the level of instantaneity required by the receiving end, for example, when the requirement to instantaneity by the receiving end is relatively high, for example, if what the receiving ends receives is online video data, then the value of N can be set larger. Alternatively, when the requirement to instantaneity by the receiving end is not high, for example, if what the receiving end receives is download service data, then the value of N can be set smaller. Certainly, it should readily be understand that other strategies can also be employed, which will be not be described redundantly here.

In addition to placing the duplicated N subpackets at the position set in the aggregated packet, more preferably, in order to improve the successful transmission rate of the retransmitted data packets, the duplicated N subpackets can be placed in the aggregated packet randomly or pseudo-randomly, thus reducing the transmission failure resulting from factor, such as channel burst noise. As shown in FIG. 9, the duplicated two subpackets S2 are placed at the position calculated pseudo-randomly.

In this way, the probability of the receiving end successfully receiving the retransmitted subpackets is improved, so that the subpackets held-up in the receiving cache can be sent to the upper layer as quickly as possible, thereby improving the system instantaneity.

The presently contemplated embodiment of the method for solving the problem associated with the hold-up effect can be applied in the above-mentioned point-to-multipoint packet aggregation transmission in addition to being applied in the scenario of point-to-point transmission, i.e., after having determined a receiving end at the current transmitting time, the manner of duplicating N copies of the retransmitted subpackets can be employed during the packet aggregation transmission for this receiving end to reduce the hold-up effect of the receiving end.

FIG. 10 is a schematic block diagram of the structure of an apparatus in accordance with another embodiment of the invention for the method provided by embodiment III. With reference to FIG. 10, the apparatus may comprise a response processing unit 1000, a packet duplication unit 1001 and an aggregation transmission unit 1002.

The response processing unit 1000 is used for deleting successfully transmitted subpackets from the transmitting queue in accordance with a returned response from the receiving end regarding the packet aggregation transmission and for sending a process notification to the packet duplication unit 1001.

The packet duplication unit 1001 is used for duplicating N copies of the subpackets to be retransmitted in the transmitting queue after having received the process notification.

The aggregation transmission unit 1002 is used for performing a packet aggregation transmission to the duplicated N subpackets together with the subpackets sent into the transmitting queue from the transmitting cache. Here, N is an integer greater than 1. In particular, N can be a preset value, N is a value related to the retransmission times for the subpackets to be retransmitted and/or N is a value related to the instantaneity requirement at the receiving end.

Moreover, the aggregation transmission unit 1002 can place these N subpackets at a position set in the aggregated packet or at a position calculated randomly or pseudo-randomly in the aggregated packet during the process of performing the packet aggregation transmission.

It can be seen from the above technical solutions that the contemplated embodiments of the invention provide a particular method for packet aggregation transmission for the point-to-multipoint transmission scenario, determines for each receiving end the hold-up condition of the subpackets at the transmitting and receiving ends, determines the receiving end corresponding to the worst hold-up condition of the subpackets at the transmitting and receiving ends, and performs a preferential packet aggregation transmission to this receiving end at the current transmitting time. By solving the problem of transmission time sequence for a plurality of receiving ends in this way, the contemplated embodiments of the invention improve the system instantaneity to the maximum degree possible.

The present invention also improves the probability of the receiving end successfully receiving retransmitted subpackets by duplicating N copies of the retransmitted subpackets together with performing packet aggregation transmission to the subpackets sent into the transmitting queue from the transmitting cache, enabling the subpackets held-up in the receiving cache to be sent to the upper layer as quickly as possible, thus improving the instantaneity of the system.

What are described above are merely preferred embodiments of the present invention and are not intended to limit the present invention, and any modification, equivalents, improvements made in the spirit and principle of the present invention shall be included in the protective scope of the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for packet aggregation transmission in a system comprising a transmitting end and at least two receiving ends, the method comprising:
A. determining, in the system, for each of the receiving ends a respective hold-up condition of subpackets at the transmitting end and the each of the receiving end at a current transmitting time; and
B. determining, in the system, a determined receiving end as one of the at least two receiving ends corresponding to a worst hold-up condition of the subpackets at the transmitting end and the each of the receiving ends, and performing a packet aggregation transmission to the determined receiving end at the current transmitting time.

2. The method according to claim 1, wherein the hold-up condition of the subpackets at the transmitting and the each of the receiving ends is a sum Nᵢ of a number of the subpackets held-up at the transmitting and the each of the receiving ends, wherein i is an identifier of the receiving end; and wherein the determined receiver end is the receiving end corresponding to a maximum value of the sum Nᵢ.

3. The method according to claim 2, wherein, when said system uses a mechanism of distributed coordination function (DCF) mechanism, the sum Nᵢ meets the equation Nᵢ=Sᵢ^{D1}−Sᵢ^{D2}, where Sᵢ^{D1} is a largest serial number of the subpacket in a transmitting cache at the transmitting end corresponding to the receiving end with an identifier i at the current transmitting time, and Sᵢ^{D2} is a smallest serial number of the subpacket in a transmitting queue at the transmitting end corresponding to the receiving end with the identifier i at the current transmitting time; and
wherein, when said system uses a point coordination function (PCF) mechanism, the value of said Nᵢ is Nᵢ=aᵢ(Sᵢ^{D1}−Sᵢ^{D2})+bᵢ(Sᵢ^{U1}+Sᵢ^{U2}), where Sᵢ^{U1} is a largest serial number of the subpacket in a receiving cache at the transmitting end corresponding to the receiving end with the identifier i at the current transmitting time, Sᵢ^{U2} is a smallest serial number of the subpacket in the receiving cache at the transmitting end corresponding to the receiving end with the identifier i at the current transmitting time, aᵢ is a weight value of a transmission urgency of downstream data corresponding to the receiving end with the identifier i, and bᵢ is a weight value of a transmission urgency of upstream data corresponding to the receiving end with the identifier i.

4. The method according to claim 1, wherein the hold-up condition of the subpackets at the transmitting end and the each of the receiving ends is a sum Tᵢ of the hold-up time period of the subpackets at said transmitting end and the each of the receiving ends, and wherein i is an identifier of the receiving end; and the determined receiving end is the receiving end corresponding to a maximum value of Tᵢ.

5. The method according to claim 4, wherein, when said system uses a mechanism of distributed coordination function (DCF) mechanism, Tᵢ is Tᵢ=Tᵢ^{D1}−Tᵢ^{D2}, where Tᵢ^{D1} is a largest time stamp value of the subpacket in a transmitting cache at the transmitting end corresponding to the receiving end with the identifier i at the current transmitting time, and Tᵢ^{D2} is a smallest time stamp value of the subpacket in a transmitting queue at the transmitting end corresponding to the receiving end with the identifier i at the current transmitting time; and
wherein, when said system uses a mechanism of point coordination function (PCF) mechanism, a value of Tᵢ is Tᵢ=aᵢ(Tᵢ^{D1}−Tᵢ^{D2})+bᵢ(Tᵢ^{U1}+Tᵢ^{U2}), where Tⁱ^{U1} is the largest time stamp value of the subpacket in the receiving cache at a transmitting end corresponding to the receiving end with the identifier i at the current transmitting time, Tᵢ^{U2} is a smallest time stamp value of the subpacket in the receiving cache at the transmitting end corresponding to the receiving end with the identifier i at the current transmitting time, aᵢ is a weight value of a transmission urgency of downstream data corresponding to the receiving end with the identifier i, and bᵢ is a weight value of the transmission urgency of upstream data corresponding to the receiving end with the identifier i.

6. The method according to claim 1, wherein after said step B, the method further comprises:
deleting by said transmitting end successfully transmitted subpackets from a transmitting queue at the transmitting end corresponding to the determined receiving end in accordance with a returned response from the determined receiving end regarding the packet aggregation transmission, and proceeding to step A at a next transmitting time.

7. An apparatus for packet aggregation transmission in a system comprising a transmitting end and at least two receiving ends, the apparatus being is set at the transmitting end, the apparatus comprising:
a hold-up condition determination unit configured to determine for each of the receiving ends respectively a hold-up condition of subpackets at the transmitting and the each of the receiving ends at a current transmitting time;
a receiving end determination unit configured to determine a determined as one of the at least two receiving ends corresponding to a worst hold-up condition of the subpackets at the transmitting and receiving ends; and
an aggregation transmission unit configured to perform a packet aggregation transmission to the determined receiving end determined by said receiving end determination unit at the current transmitting time.

8. The apparatus according to claim 7, wherein said hold-up condition of the subpackets at the transmitting end and the each of the receiving ends is a sum Nᵢ of a number of subpackets held-up at the transmitting enc and the each of the receiving ends, where i is an identifier of the receiving end; and
wherein the determined receiving end is the receiving end corresponding to the maximum value of Nᵢ.

9. The apparatus according to claim 8, wherein, when said system uses a mechanism of distributed coordination function (DCF) mechanism, the hold-up condition determination unit comprises:
a first serial number determination sub-unit configured to determine Sᵢ^{D1} and Sᵢ^{D2} respectively for the each of the receiving ends, where Sᵢ^{D1} is a largest serial number of the subpacket in a transmitting cache at the transmitting end corresponding to the receiving end with the identifier i at the current transmitting time, and Sᵢ^{D2} is a smallest serial number of the subpacket in the transmitting queue at the transmitting end corresponding to the receiving end with the identifier i at the current transmitting time; and
a first hold-up number determination sub-unit configured to determine the number Nᵢ of the subpackets held-up at the transmitting and the each of the receiving ends in accordance with Nᵢ=Sᵢ^{D1}−Sᵢ^{D2}; and
wherein, when the system uses a point coordination function (PCF) mechanism, the hold-up condition determination unit comprises:
a second serial number determination sub-unit for determining Sᵢ^{D1}, Sᵢ^{D2}, Sᵢ^{U1} and Sᵢ^{U2} respectively for the each of the receiving ends, where Sᵢ^{U1} is a largest serial number of the subpacket in a receiving cache at the transmitting end corresponding to the receiving end with the identifier i at the current transmitting time, and Sᵢ^{U2} is a smallest serial number of the subpacket in the receiving cache at the transmitting end corresponding to the receiving end with the identifier i at the current transmitting time; and
a second hold-up number determination sub-unit configured to determines a number Nᵢ of the subpackets held-up at the transmitting and receiving ends in accordance with Nᵢ=aᵢ(Sᵢ^{D1}−Sᵢ_{D2})+bᵢ(Sᵢ^{U1}−Sᵢ^{U2}) where aᵢ is a weight value of a transmission urgency of downstream data corresponding to the receiving end with the identifier i, and bᵢ is a weight value of the transmission urgency of upstream data corresponding to the receiving end with the identifier i.

10. The apparatus according to claim 7, wherein the hold-up condition of the subpackets at the transmitting end and the each of the receiving ends is a sum Tᵢ of a hold-up time period of the subpackets at the transmitting end and the each of the receiving ends, where i is an identifier of the receiving end; and
wherein the determined receiving end is the receiving end corresponding to the maximum value of Tᵢ.

11. The apparatus according to claim 10, wherein, when the system uses a distributed coordination function (DCF) mechanism, the hold-up condition determination unit comprises:
a first time stamp determination sub-unit configured to determine Tᵢ^{D1} and Tᵢ^{D2} respectively for the each of the receiving ends, where Tᵢ^{D1} is a largest time stamp value of the subpacket in a transmitting cache at the transmitting end corresponding to the receiving end with the identifier i at the current transmitting time, and Tᵢ^{D2} is a smallest time stamp value of the subpacket in the transmitting queue at the transmitting end corresponding to the receiving end with the identifier i at the current transmitting time; and
a first hold-up time period determination sub-unit configured to determine the sum Tᵢ of the hold-up time period of the subpackets at the transmitting end and the each of the receiving ends according to Tᵢ=Tᵢ^{D1}−Tᵢ^{D2}; and
wherein, when the system uses a point coordination function (PCF) mechanism, the hold-up condition determination unit comprises:
a second time stamp determination sub-unit configured to determine Tᵢ^{D1}, Tᵢ^{D2}, Tᵢ^{U1} and Tᵢ^{U2} respectively for the each of the receiving ends, where Tⁱ^{U1} is a largest time stamp value of the subpacket in a receiving cache at the transmitting end corresponding to the receiving end with the identifier i at the current transmitting time, and Tᵢ^{U2} is a smallest time stamp value of the subpacket in the receiving cache at the transmitting end corresponding to the receiving end with the identifier i at the current transmitting time; and
a second hold-up time period determination sub-unit configured to determine the sum Tᵢ of the hold-up time period of the subpackets at the transmitting end and the each of the receiving ends according to) Tᵢ=aᵢ(Tᵢ^{D1}−Tᵢ^{D2})+bᵢ(Tᵢ^{U1}+−Tᵢ^{U2}), where aᵢ is a weight value of the transmission urgency of downstream data corresponding to the receiving end with the identifier i, and bᵢ is a weight value of a transmission urgency of upstream data corresponding to the receiving end with the identifier i.

12. The apparatus according to claim 7, further comprising:
a transmission response processing unit configured to delete successfully transmitted subpackets from a transmitting queue at the transmitting end corresponding to said determined receiving end in accordance with a returned response from the determined receiving end regarding the packet aggregation transmission.

13. A method for packet aggregation transmission, comprising:
duplicating, by a transmitting end of a system, N copies of subpackets to be retransmitted in a transmitting queue after deleting successfully transmitted subpackets from the transmitting queue according to a returned response from a receiving end regarding a packet aggregation transmission; and
performing a packet aggregation transmission of the N subpackets together with the subpackets sent into the transmitting queue from a transmitting cache;
wherein, N is an integer greater than 1.

14. The method according to claim 13, wherein N is one of a preset value, a value related to retransmission times for said subpackets to be retransmitted and a value related to an instantaneity requirement at the receiving end.

15. The method according to claim 13, wherein, during the step of performing the packet aggregation transmission, N subpackets are one of placed at a position set in an aggregated packet and placed at a position calculated one of randomly and pseudo-randomly in the aggregated packet.

16. The method according to claim 14, wherein, during the step of performing the packet aggregation transmission, N subpackets are one of placed at a position set in an aggregated packet and placed at a position calculated one of randomly and pseudo-randomly in the aggregated packet.

17. An apparatus for packet aggregation transmission, said apparatus being set at a transmitting end, the apparatus comprising:
a response processing unit configured to delete successfully transmitted subpackets from the transmitting queue in accordance with a returned response from a receiving end regarding a packet aggregation transmission and to send a process notification to said packet duplication unit;
a packet duplication unit configured to duplicate N copies of subpackets to be retransmitted in a transmitting queue after having received said process notification; and
an aggregation transmission unit configured to perform the packet aggregation transmission of the duplicated N subpackets together with the subpackets sent into the transmitting queue from a transmitting cache;
wherein, N is an integer greater than 1.

18. The apparatus according to claim 17, wherein N is one of a preset value, a value related to the retransmission times for said subpackets to be retransmitted and a value related to the instantaneity requirement at said receiving end.

19. The apparatus according to claim 17, wherein, during said packet aggregation transmission, said aggregation transmission unit places N subpackets one of at a position set in an aggregated packet and at a position calculated one of randomly and pseudo-randomly in the aggregated packet.

20. The apparatus according to claim 18, wherein, during said packet aggregation transmission, said aggregation transmission unit places N subpackets one of at a position set in an aggregated packet and at a position calculated one of randomly and pseudo-randomly in the aggregated packet.
